(19) United States
(12) Patent Application Publication
(10) Pub. No.: US 2025/0247899 A1
(43) Pub. Date: Jul. 31, 2025

(54) PRIORITY-BASED BANDWIDTH ALLOCATION

(71) Applicant: T-Mobile USA, Inc., Bellevue, WA (US)

(72) Inventors: Ryan P. Dreiling, Shawnee, KS (US); Christopher Bailey, Overland Park, KS (US)

(21) Appl. No.: 18/423,746

(22) Filed: Jan. 26, 2024

(51) Int. Cl. H04W 76/10; H04W 8/00; H04W 84/04

(52) U.S. Cl. CPC H04W 76/10; H04W 8/005; H04W 84/042

(57) ABSTRACT

Described herein are systems and methods for dynamically selecting network scanning rates for electronic devices. For instance, a system select a scanning rate for a mobile device to scan at. The system can access a programmable table that stores scanning rates in association with identifiers of mobile networks and/or access nodes the mobile device can connect to. The scanning rates may vary based on whether the associated mobile network is (1) associated with the mobile device (e.g., the “home” network), (2) associated with a mobile network in a partnership with the home mobile network, and (3) associated with a mobile network not in a partnership with the home mobile network. The scanning rates may also vary based on the associated access node being terrestrial (e.g., located on the surface of the earth) or extraterrestrial (e.g., located beyond the surface of the earth), such as a satellite.

### BACKGROUND

In telecommunications, 5G is the fifth-generation technology standard for cellular networks, which cellular phone companies began deploying worldwide in 2019, and is the successor to 4G technology that provides connectivity to most current mobile phones. Like its predecessors, 5G networks are cellular networks, in which the service area is divided into small geographical areas called cells. All 5G wireless devices in a cell are connected to the Internet and the telephone network by radio waves through a base station and antennae in the cell. The new networks have higher download speeds, with a peak speed of 10 gigabits per second (Gbit/s) when there is only one user in the network. 5G has higher bandwidth to deliver faster speeds than 4G and can connect more devices, improving the quality of Internet services in crowded areas. Due to the increased bandwidth, it is expected the 5G networks will increasingly be used as general internet service providers (ISPs), competing with existing ISPs such as cable internet, and also will make possible new applications in internet-of-things (IoT) and machine-to-machine areas.

5G NR (New Radio) is a new radio access technology (RAT) developed by the 3rd Generation Partnership Project (3GPP) for the 5G (fifth generation) mobile network. It was designed to be the global standard for the air interface of 5G networks. It is based on orthogonal frequency-division multiplexing (OFDM), as is the 4G (fourth generation) long-term evolution (LTE) standard. Initial 5G NR launches depended on pairing with existing LTE (4G) infrastructure in non-standalone (NSA) mode (5G NR radio with 4G core), before maturation of the standalone (SA) mode with the 5G core network.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a manager node capable of selecting scanning rates, according to some embodiments.

FIG. 3 is a flow diagram that illustrates a process for causing a mobile device to scan at a first scanning rate, according to some embodiments.

FIG. 4A is a block diagram of representing an electronic device connected to a satellite, according to some embodiments.

FIG. 4B is a block diagram representing an electronic device connected to a first access node, to a network access node, according to some embodiments.

FIG. 4C is a block diagram of an electronic device connected to a second access node, according to some embodiments.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Network coverage has conventionally been provided by terrestrial access nodes rather than extraterrestrial access nodes. Though the use of extraterrestrial access nodes, such as satellites) has expanded the geographic areas that electronic devices may receive coverage in, these access nodes may provide slower and more costly network coverage compared to their terrestrial counterparts. Further, as global communication needs have expanded, mobile networks have formed partnerships with one another such that they provide faster network connection at lower cost to mobile devices associated with their partners compared to other mobile devices.

The systems and methods disclosed herein enable dynamic selection of scanning rates for electronic devices. Though scanning is described herein in relation to finding higher-priority networks (e.g., higher priority search interval), electronic devices may also scan for a variety of reasons, such as for discovering Internet Protocol (IP) addresses, operating systems, topology, vulnerabilities, and the like. The scanning rates are stored in a programmable table in association with mobile networks and/or access nodes. To optimize network coverage for an electronic device to be fast, reliable, and low-cost, the scanning rates vary based on their associated access nodes and mobile networks compared to the “home” mobile network that traditionally provides coverage to the electronic device. For instance, for the same type (e.g., terrestrial or extraterrestrial) access node, scanning rates are relatively higher for third-party mobile networks than scanning rates of an electronic device's home mobile network and higher for non-partner mobile networks than scanning rates of partner networks. For the same mobile network, scanning rates are relatively higher (e.g., unfavorable) for extraterrestrial access nodes than scanning rates of terrestrial access nodes. Upon establishing a new connection for network coverage, an electronic device can retrieve a scanning rate associated with the access node and/or mobile network associated with the connection and scan at that rate until establishing a new connection. This enables the electronic device to search more quickly for new connections when in an unfavorable connection (less optimal than being connection to its home mobile network via a terrestrial access node) than when in a relatively favorable connection.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

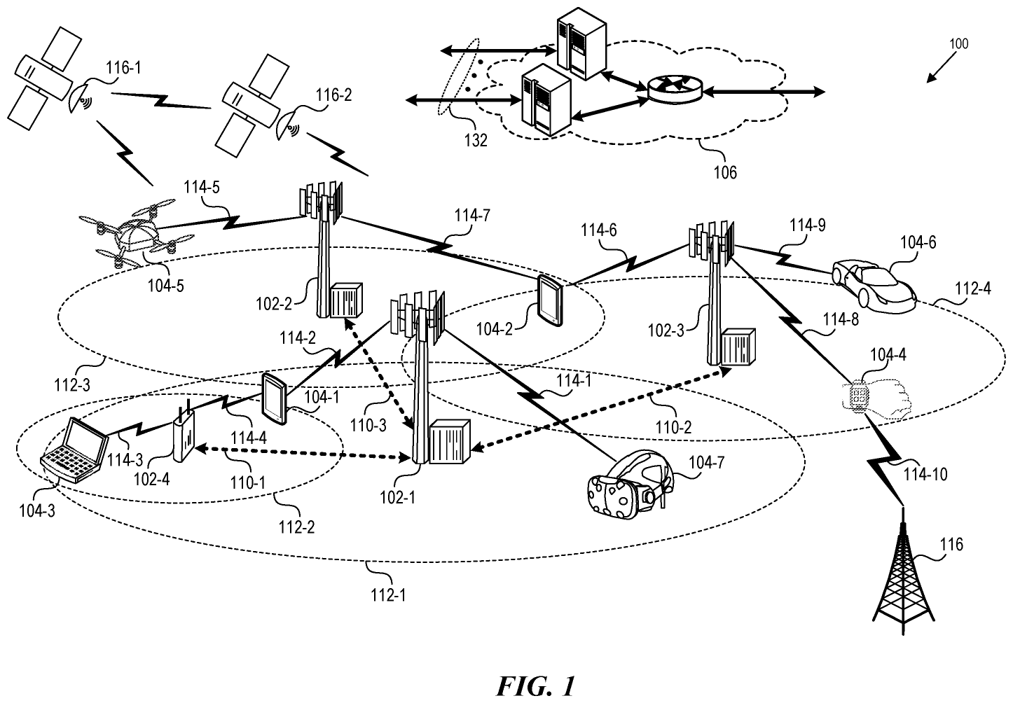

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Dynamic Timer Value Selection

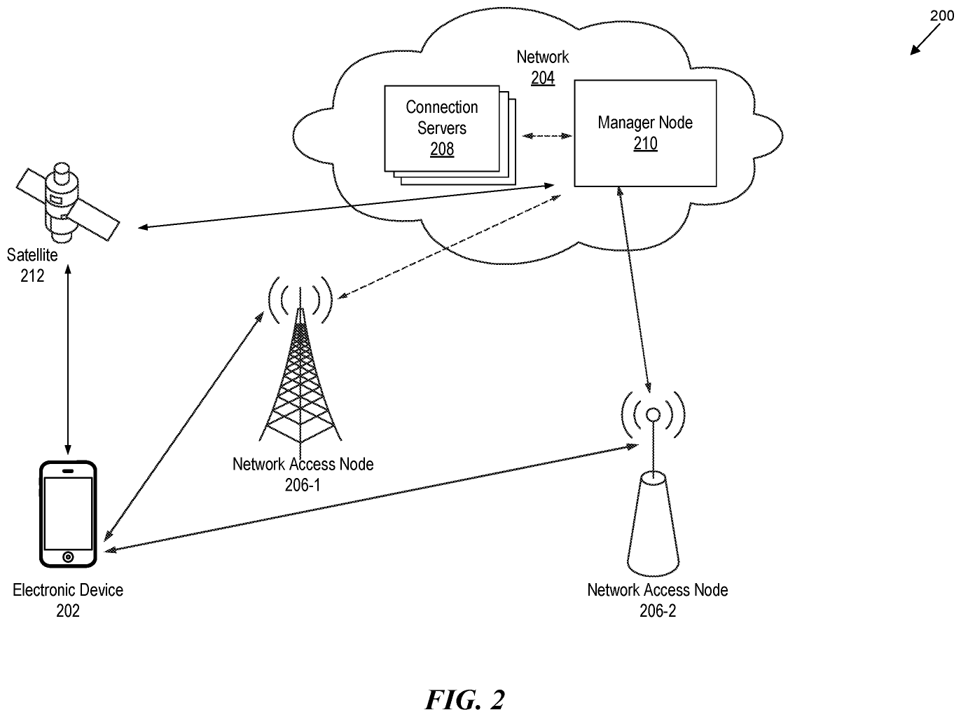

FIG. 2 is a block diagram that illustrates a manager node 210 capable of selecting scanning rates, according to some embodiments. The environment 200 includes an electronic device 202 that is communicatively coupled to one or more networks 204 via network access nodes 206-1 and 206-2 (referred to collectively as network access nodes 206) and/or a satellite 212.

The electronic device 202 (which may be wireless device 104 from FIG. 1) is any type of electronic device that can communicate wirelessly with a network node and/or with another electronic device in a cellular, computer, and/or mobile communications system. Examples of the electronic device 202 includes smartphones (e.g., Apple iPhone, Samsung Galaxy), tablet computers (e.g., Apple iPad, Samsung Note, Amazon Fire, Microsoft Surface), wireless devices capable of M2M communication, wearable electronic devices, movable IoT devices, and any other handheld device that is capable of accessing the network(s) 204. Although only one electronic device 202 is illustrated in FIG. 2, the disclosed embodiments can include any number of electronic devices.

The electronic device 202 can store and transmit (e.g., internally and/or with other electronic devices over a network) code (composed of software instructions) and data using machine-readable media, such as non-transitory machine-readable media (e.g., machine-readable storage media such as magnetic disks, optical disks, read-only memory (ROM), flash memory devices, and phase change memory) and transitory machine-readable transmission media (e.g., electrical, optical, acoustical, or other forms of propagated signals, such as carrier waves or infrared signals).

The electronic device 202 can include hardware such as one or more processors coupled to sensors and a non-transitory machine-readable media to store code and/or sensor data, user input/output (I/O) devices (e.g., a keyboard, a touchscreen, and/or a display), and network connections (e.g., an antenna) to transmit code and/or data using propagating signals. The coupling of the processor(s) and other components is typically through one or more buses and bridges (also referred to as bus controllers). Thus, a non-transitory machine-readable medium of a given electronic device typically stores instructions for execution on a processor(s) of that electronic device. One or more parts of an embodiment of the present disclosure can be implemented using different combinations of software, firmware, and/or hardware.

The network access nodes 206 can be any type of radio network node that can communicate with a wireless device (e.g., electronic device 202) and/or with another network node. The network access nodes 206 can be a network device or apparatus. Examples of network access nodes include a base station (e.g., network access node 206-1), an access point (e.g., network access node 206-2), or any other type of network node such as a network controller, radio network controller (RNC), base station controller (BSC), a relay, transmission points, and the like.

Each network access node 206 can be associated with a geographic area that the network access node 206 provides network coverage for. The geographic areas can be shaped as one or more types of polygons (or circles) encompassing all or a portion of a geographic range that a network access node 206 associated with a respective geographic area can provide connection and signals within. For example, a network access node 206-1 may be able to send and receive signals a mile in any direction. In this example, the geographic area of the network access node 206-1 may be a circular area with a radius of one mile and the network access node 206-1 at its center or may be a square-shaped area that fits within the circular area (e.g., does not have a diagonal larger than two miles). The geographic areas can form a grid covering a geographic region that encompasses the geographic areas. For example, a geographic area may be shaped as a hexagon that borders six other hexagonal geographic areas. The network access node 206 of the geographic area may provide network coverage (e.g., connection to the network 204) associate with the manager node 210, while the network access nodes 206 of the border geographic areas may not provide such network coverage. Identifiers of network access nodes 206 associated with respective geographic areas and/or systems (e.g., the telecommunications network 100, a third-party system, etc.) can be stored in a connection database at the manager node 210.

Satellite 212 can create a communication channel between a wireless device (e.g., electronic device 202) and the network 204. Though only one satellite 212 is shown in FIG. 2, any number of satellites may communicate with electronic devices and the network 204 or may be another high-altitude platform or non-terrestrial network. The satellite 212 can be very high up in the atmosphere, typically between 100 km to 40,000 km above the Earth's surface, resulting in high attenuation of the signal between the electronic device 202 and the satellite 212. The satellite 212 may appear stationary at the same point in the sky such that the satellite dish antennas (not shown in FIG. 2) of ground stations can be aimed permanently at that spot and do not have to move to track the satellite. In some instances, the satellite 212 may be in low Earth orbit, resulting in the antennas on the ground needing to follow the position of the satellite 212 and switch between satellites as they move in and out of range. The satellite 212 can be associated with a geographic area that the satellite 212 provides network coverage to. The geographic area may be included in the grid of geographic areas in the geographic region or may be overlaid on other geographic areas in the grid. The geographic area may change as the satellite 212 moves, and the satellite 212 may communicate its location with the manager node 210, which dynamically updates the connection database to indicate a current version of the satellite's geographic area based on its location. The satellite 212 can connect to the Internet (and network 204) via broadband data connections. This can be very useful for users of electronic devices 202 who are located in remote areas and cannot access a broadband connection or require high availability of services.

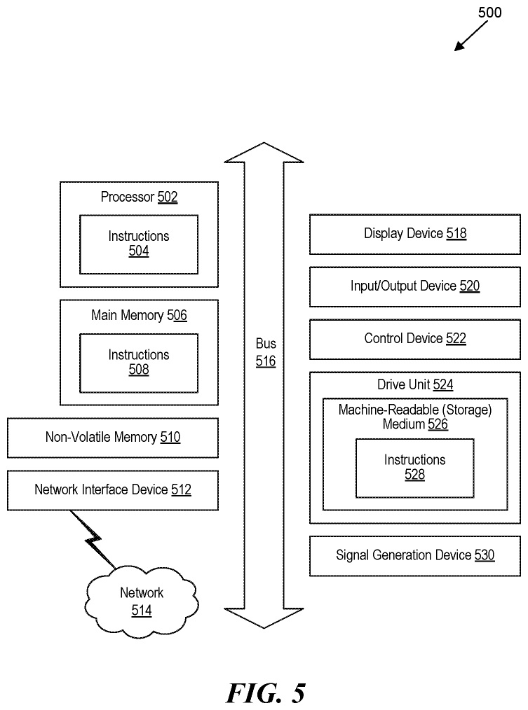

The network 204 can include a 5G network, as described in relation to FIG. 1. The network 204 can include connection servers 208, which facilitate the telecommunications network 100 and connections between electronic devices 202 and network access nodes 206, and a manager node 210. For example, the manager node 210 can include hardware or software components associated with the functioning of the network access node 206-2, including storage, processors, or other components as described in relation to FIG. 5. The manager node 210 can include media capable of managing scanning rates based on coverage received at the electronic device 202. For instance, the electronic device 202 may use network access node 206-1 or network access node 206-2 (e.g., terrestrial coverage) to communicate with the network 204 or use satellite 212 (e.g., extraterrestrial coverage) to communicate with the network 204. In some instances, the manager node may be located at the satellite 212.

In some embodiments, the manager node 210 can initiate and/or terminate network connections associated with the network access nodes 206 and/or satellite 212. For example, the manager node 210 can terminate or instantiate a network connection with the electronic device 202 based on information relating to the electronic device 202 and/or associated applications. Alternatively, an electronic device 202 can determine to terminate or instantiate a network connection with a network access node 206. In some instances, the connection servers 208 initiate and terminate connections based on scans made by the electronic device, which are done at a scanning rate determined by the manger node 210.

The manager node 210 receives information describing the electronic device's 202 network connection(s). Though the following is described in relation to manager node 210, in other instances, connection servers 208 perform some of the actions used to determine and broadcast scanning rates. Further, in some instances, the manager node 210 can be located at the electronic device 202. The indications can include identifiers such as multimedia messaging country codes (MCCs), mobile network codes (MNCs), or public land mobile networks (PLMNs). A PLMN may be a combination of an MCC and MNC. The manager node 210 can use each indication to identify a mobile carrier (e.g., telecommunications network 100 or a third-party system) associated with a network access node 206 or satellite 212 (henceforth collectively referred to as connection nodes) the electronic device 202 has established a connection with. For example, an MCC of “310” in combination with an MNC of “260” may be associated with the telecommunications network 100 whereas an MCC of “311” with an MNC of “410” may be associated with a third-party system that provides its own network coverage.

The manager node 210 can access a programmable table that associates identifiers with scanning rates (also referred to as timer values herein). Though described as a table, the programmable table can be configured into any suitable data structure that can store associations between identifiers and scanning rates. In some instances, an indication may include an identifier of the connection node that is facilitating the connection for the electronic device 202 and the manager node 210 further stores identifiers of connection nodes in association with each mobile carrier-scanning rate combination. programmable table may be stored at the manager node 210 or at one or more connection servers 208 and/or may be accessible by the manager node 210 via the network 204. In some instances, the programmable table is stored at the electronic device 202 such that the manager node 210, when stored at the electronic device 202, can access the programmable table without network connection. The manager node 210 may update the programmable table to include new identifiers and scanning rates or to alter existing scanning rates periodically, upon request by an operator, etc.

The values scanning rates in the programmable table can correspond to characteristics of the associated mobile carriers and/or connection nodes. The characteristics can correspond to a level of “favorability” of the electronic device 202 receiving network coverage via the associated mobile carrier and/or connection node. Characteristics can include partnership standing of the mobile carriers. For example, network coverage to the telecommunications network 100 of the electronic device 202 can be considered more favorable (also referred to as higher priority) than network coverage from a third-party system because the electronic device 202 may receive better (e.g., faster, lower cost) network connection from the telecommunications network 100 than a third-party system. However, network coverage from a third-party system that is in a partnership with the telecommunications network 100 can be considered more favorable than network coverage from a third-party system that does not have a partnership with the telecommunications system. This is because partner third-party systems may provide better (e.g., lower cost to the telecommunications network 100, faster network connection speed, etc.) network coverage to electronic devices 202 associated with the telecommunications network 100 than non-partner third-party systems. Thus, scanning rates associated with the telecommunications network 100 itself may be lower than scanning rates associated with partner third-party systems, which may be lower than scanning rates associated with non-partner third-party systems. By using these scanning rates, the electronic device 202 can scan more often for different network coverage when receiving coverage from a third-party system in an effort to quickly switch back to a more favorable network coverage and can scan less often for different network coverage when receiving coverage from the telecommunications network 100 in order to prolong use of the favorable network coverage.

Characteristics can also include types of connection nodes. For instance, network coverage to terrestrial connection nodes (e.g., connection nodes located at or below the surface of the earth) can be considered favorable to network coverage provided by extraterrestrial connection nodes (e.g., connection nodes that are located in the atmosphere or otherwise away from the surface of the earth, like satellites 212). Thus, scanning rates associated with the terrestrial connection nodes may be lower than scanning rates associated with extraterrestrial connection nodes. Using these scanning rates, the electronic device 202 can scan more often for different network coverage when receiving coverage from an extraterrestrial connection node, like a satellite 212, in an effort to quickly switch back to a more favorable network coverage and can scan less often for different network coverage when receiving coverage from a terrestrial connection node to prolong use of the favorable network coverage.

The manager node 210 can retrieve a scanning rate from the programmable table and cause the mobile device to scan for network coverage at the scanning rate. For example, the manager node 210 can send an instruction, via the network 204, including the scanning rate, which can cause the electronic device 202 to scan at the scanning rate. In other instances, the electronic device 202 may have been programmed with the programmable table before connecting to the connection node and the manager node 210 may be located at the electronic device 202. The manager node 210 can access the programmable table to retrieve the associated scanning rate and cause the electronic device 202 to scan for network coverage at the scanning rate.

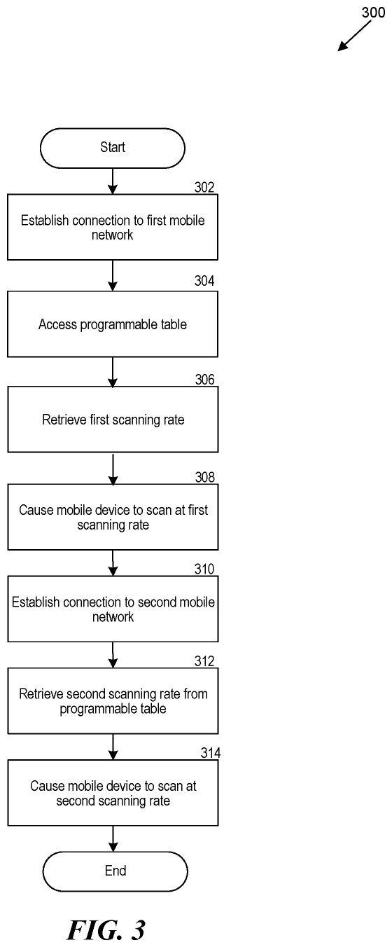

FIG. 3 is a flow diagram that illustrates a process 300 for causing a mobile device to scan at a first scanning rate, according to some embodiments. Though described in relation to the components of FIG. 2, the following process 300 may be performed using other components or systems. Further, in additional or alternative embodiments, the process may involve steps other than those shown in FIG. 3.

At step 302, the manager node 210 establishes, at an electronic device 202 associated with a telecommunications system 100, a connection to a first mobile network of a plurality of mobile networks. The first mobile network may be the telecommunications network 100, which the electronic device 202 may have an association such as a membership or coverage plan with. The telecommunications network 100 may provide network coverage to the electronic device 202 that is low cost and fast compared to coverage from other mobile networks in the plurality.

At step 304, the manager node 210 accesses, at the electronic device 202, a programmable table that stores identifiers of the plurality of mobile networks in association with scanning rates and, in some instances, in association with identifiers of connection nodes. So that the electronic device 202 can optimize its scanning to receive network coverage from a favorable mobile network, scanning rates associated with the telecommunications network 100 may be lower than scanning rates of partner mobile networks, which may be lower than scanning rates of non-partner mobile networks. Similarly, network coverage received via terrestrial connection nodes may be favorable to network coverage received via extraterrestrial connection nodes scanning rates as cost to operate terrestrial connection nodes and speed of network connection from terrestrial connection nodes may be faster than those of extraterrestrial connection nodes. Based on this, terrestrial connections nodes may be associated with lower than scanning rates than those associated with extraterrestrial connection nodes.

At step 306, the manager node 210 retrieves a first scanning rate associated with a first identifier of the first mobile network (e.g., the telecommunications network 100, in some embodiments). At step 308, the manager node 210 causes the electronic device 202 to scan for network connection at the first scanning rate. The electronic device 202 can scan at the first scanning rate until it establishes a second connection to a second mobile network that is associated with a first third-party system. At step 310, the electronic device 202 establishes a second connection to the second mobile network. The manager node 210 accesses the programmable table, and at step 312, the manager node 210 retrieves a second scanning rate associated with a second identifier of the second mobile network. Due to second mobile network being a partner or non-partner third-party network or the first connection being facilitated by a terrestrial connection node while the second connection is facilitated by an extraterrestrial connection node, the second scanning rate is higher than the first scanning rate. At step 314, the manager node causes the mobile device to scan for network connection at the second scanning rate.

In some embodiments, the process 300 may include additional or alternative steps to those shown or described in relation to FIG. 3. In some instances, the electronic device 202 establish a third connection to a third mobile network, where the third connection is associated with a partner third-party system and a terrestrial connection node. If the second connection was associated with a non-partner third-party system and a terrestrial connection node, the third scanning rate may be lower than the second scanning rate but higher than the first scanning rate. If the second connection was associated with a non-partner third-party system and an extraterrestrial connection node, the third scanning rate may be even lower than the second scanning rate. If the second connection was associated with a different partner third-party system and a terrestrial connection node, the third scanning rate may be the same as the second scanning rate. Essentially, scanning rates stored in the programmable table vary based on the associated mobile network and/or connection node, such that (1) for a given mobile network, the scanning rates are higher for associations with extraterrestrial connection nodes compared to associations with terrestrial nodes, (2) for a given connection node, the scanning rates are (a) higher for associations with third-party systems compared to associations with the telecommunications network and (b) higher for associations with non-partner third-party systems compared to associations with partner third-[party systems.

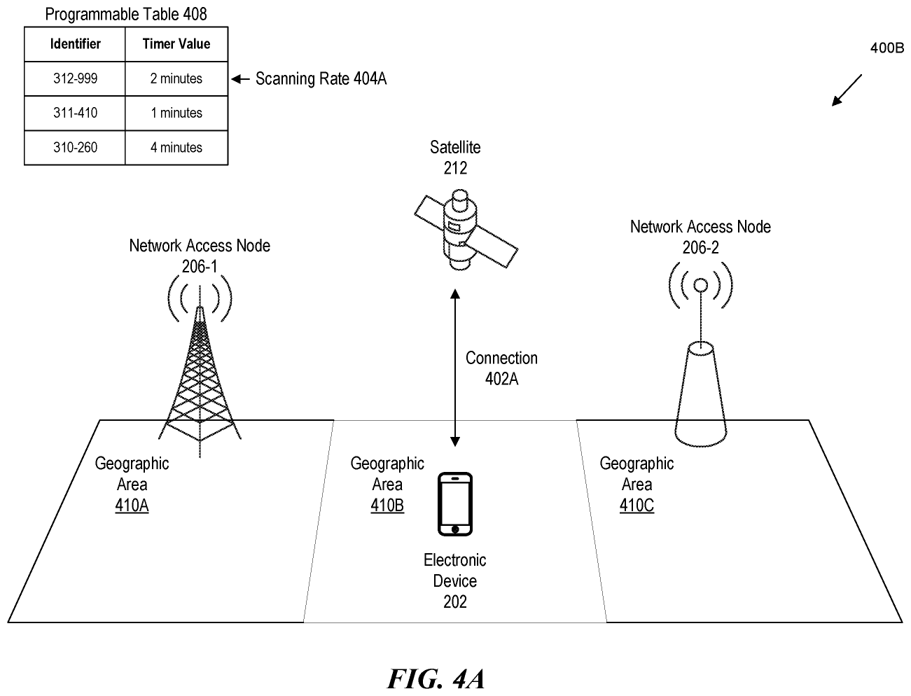

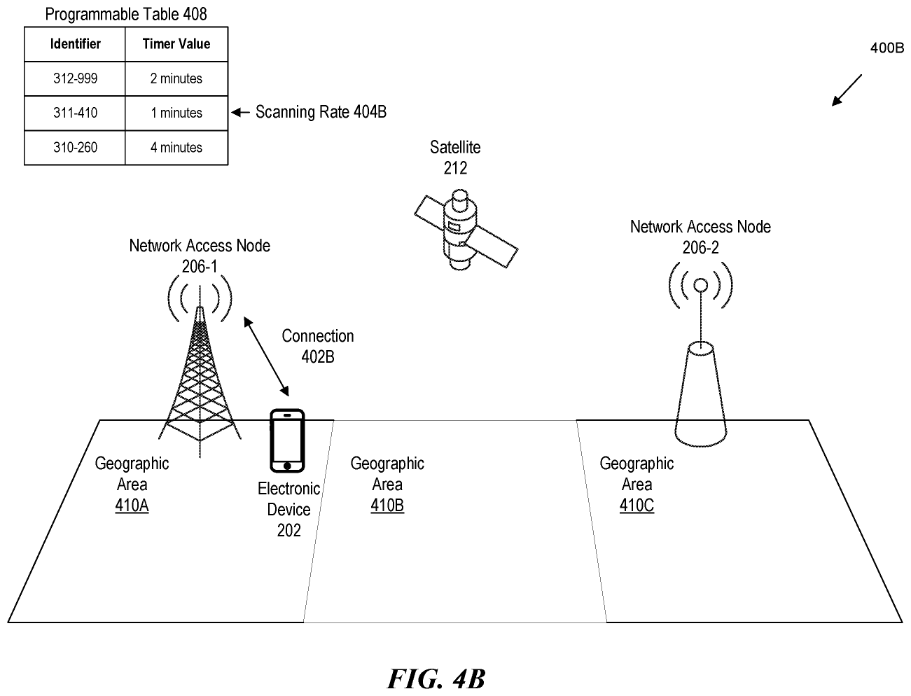

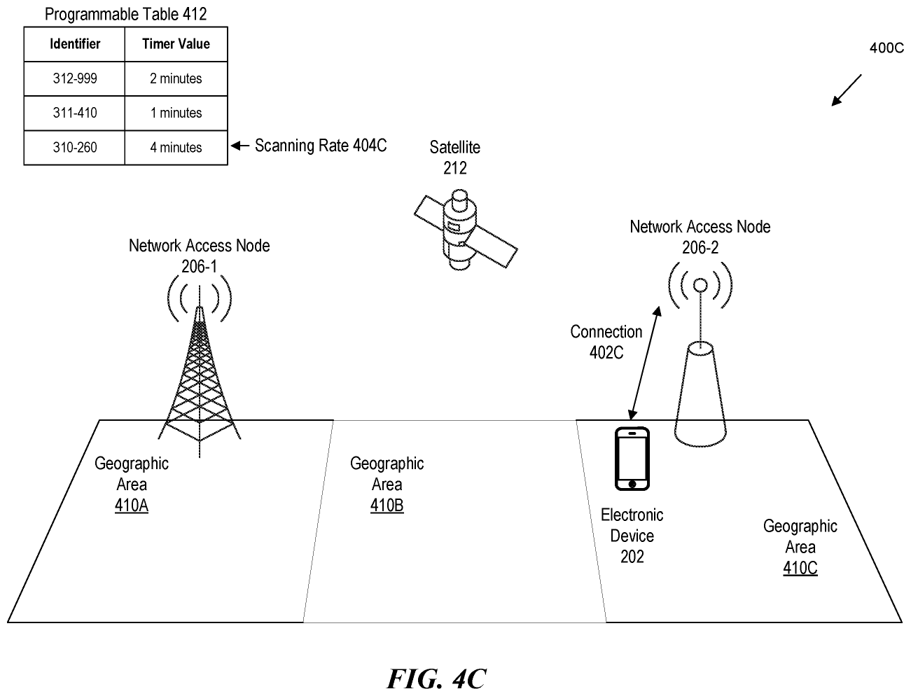

For example, FIG. 4A is a block diagram 400A of representing an electronic device 202 connected 402A to a satellite, according to some embodiments. Here, the electronic device 202 is in a geographic area 410B that the satellite 212 associated with a partner third-party system provides network coverage to and the scanning rate 404A associated with the identifier of the satellite 212 (e.g., “312-999”) is two minutes, as shown in the programmable table 408. In FIG. 4B, the electronic device 202 is connected 402B to a first network access node 206-1, which is associated with the identifier “311-410.” Though the first network access node 206-1 is terrestrial, in this example, the first network access node 206-1 is associated with a non-partner third-party system, so the scanning rate 404B in the programmable table is higher than the scanning rate 404A of the satellite 212 associated with the partner third-party system. A scanning rate 404 of an extraterrestrial network access node 206 of the non-partner third-party system would be even higher than the scanning rate 404B, and a scanning rate 404 of a terrestrial network access node of the partner third-party system would be higher than the scanning rate 404A. In FIG. 4C, the electronic device 202 is connected 402C to a second network access node 206-2, which is associated with the identifier “310-260.” The identifier indicates that the second network access node 206-2 is associated with the telecommunications network 100 that the electronic device 202 is associated with. The electronic device 202 scans at a scanning rate 404C of four minutes, which is lower than both of the other scanning rates 404A-B shown in the programmable table 408 due to the second access node 206-2 being associated with the electronic device's 202 “home” (e.g., most favorable) mobile network.

### Computer System

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions when executed by at least one data processor of a system, cause the system to perform actions comprising:
establishing, at a mobile device associated with a telecommunications system, a connection to a first mobile network of a plurality of mobile networks;
accessing, at the mobile device, a programmable table that stores identifiers of the plurality of mobile networks, each identifier associated with a scanning rate in the programmable table;
retrieving a first scanning rate associated with a first identifier of the first mobile network; and
causing the mobile device to scan for network connection at the first scanning rate.

2. The non-transitory, computer-readable storage medium of claim 1, wherein the identifiers of the plurality of mobile networks are multimedia messaging country codes (MCCs), mobile network codes (MNCs), or public land mobile networks (PLMNs).

3. The non-transitory, computer-readable storage medium of claim 1, wherein the connection to the first mobile network is facilitated by a satellite.

4. The non-transitory, computer-readable storage medium of claim 3, the actions further comprising:
responsive to establishing, at the mobile device, a second connection to a second mobile network, wherein the second mobile network is facilitated by a base station associated with a first third-party system:
retrieving, from the programmable table, a second scanning rate associated with a second identifier of the second mobile network, wherein the second scanning rate is higher than the first scanning rate; and
causing the mobile device to scan for network connection at the second scanning rate.

5. The non-transitory, computer-readable storage medium of claim 4, the actions further comprising:
responsive to establishing, at the mobile device, a third connection to a third mobile network, wherein the third mobile network is associated with a partner third-party system:
retrieving, from the programmable table, a third scanning rate associated with a third identifier of the third mobile network, wherein the third scanning rate is higher than the first scanning rate and lower than the second scanning rate; and
causing the mobile device to scan for network connection at the third scanning rate.

6. The non-transitory, computer-readable storage medium of claim 1, wherein:
the programmable table stores identifiers of one or more access nodes associated with the telecommunications system,
each identifier is associated with a scanning rate, and
the scanning rates associated with identifiers of extraterrestrial access nodes are higher than the scanning rates of terrestrial scanning nodes.

7. The non-transitory, computer-readable storage medium of claim 1, wherein:
the programmable table stores identifiers of a first set of access nodes associated with partner third-party systems and a second set of access nodes associated with non-partner third-party systems,
each identifier is associated with a scanning rate, and
the scanning rates associated with the first set of access nodes lower than the scanning rates of the second set of access nodes.

8. A method comprising:
establishing, at a mobile device associated with a telecommunications system, a connection to a first mobile network of a plurality of mobile networks;
accessing, at the mobile device, a programmable table that stores identifiers of the plurality of mobile networks, each identifier associated with a scanning rate in the programmable table;
retrieving a first scanning rate associated with a first identifier of the first mobile network; and
causing the mobile device to scan for network connection at the first scanning rate.

9. The method of claim 8, wherein the identifiers of the plurality of mobile networks are multimedia messaging country codes (MCCs), mobile network codes (MNCs), or public land mobile networks (PLMNs).

10. The method of claim 8, wherein the connection to the first mobile network is facilitated by a satellite.

11. The method of claim 10, the method further comprising:
responsive to establishing, at the mobile device, a second connection to a second mobile network, wherein the second mobile network is facilitated by a base station associated with a first third-party system:
retrieving, from the programmable table, a second scanning rate associated with a second identifier of the second mobile network, wherein the second scanning rate is higher than the first scanning rate; and
causing the mobile device to scan for network connection at the second scanning rate.

12. The method of claim 11, the method further comprising:
responsive to establishing, at the mobile device, a third connection to a third mobile network, wherein the third mobile network is associated with a partner third-party system:
retrieving, from the programmable table, a third scanning rate associated with a third identifier of the third mobile network, wherein the third scanning rate is higher than the first scanning rate and lower than the second scanning rate; and
causing the mobile device to scan for network connection at the third scanning rate.

13. The method of claim 8, wherein:
the programmable table stores identifiers of one or more access nodes associated with the telecommunications system,
each identifier is associated with a scanning rate, and
the scanning rates associated with identifiers of extraterrestrial access nodes are higher than the scanning rates of terrestrial scanning nodes.

14. The method of claim 8, wherein:
the programmable table stores identifiers of a first set of access nodes associated with partner third-party systems and a second set of access nodes associated with non-partner third-party systems,
each identifier is associated with a scanning rate, and
the scanning rates associated with the first set of access nodes lower than the scanning rates of the second set of access nodes.

15. A system comprising:
at least one hardware processor; and
at least one non-transitory memory storing instructions, which, when executed by the at least one hardware processor, cause the system to perform actions comprising:
establishing, at a mobile device associated with a telecommunications system, a connection to a first mobile network of a plurality of mobile networks;
accessing, at the mobile device, a programmable table that stores identifiers of the plurality of mobile networks, each identifier associated with a scanning rate in the programmable table;
retrieving a first scanning rate associated with a first identifier of the first mobile network; and
causing the mobile device to scan for network connection at the first scanning rate.

16. The system of claim 15, wherein the identifiers of the plurality of mobile networks are multimedia messaging country codes (MCCs), mobile network codes (MNCs), or public land mobile networks (PLMNs).

17. The system of claim 15, wherein the connection to the first mobile network is facilitated by a satellite.

18. The system of claim 17, the actions further comprising:
responsive to establishing, at the mobile device, a second connection to a second mobile network, wherein the second mobile network is facilitated by a base station associated with a first third-party system:
retrieving, from the programmable table, a second scanning rate associated with a second identifier of the second mobile network, wherein the second scanning rate is higher than the first scanning rate; and
causing the mobile device to scan for network connection at the second scanning rate.

19. The system of claim 18, the actions further comprising:
responsive to establishing, at the mobile device, a third connection to a third mobile network, wherein the third mobile network is associated with a partner third-party system:
retrieving, from the programmable table, a third scanning rate associated with a third identifier of the third mobile network, wherein the third scanning rate is higher than the first scanning rate and lower than the second scanning rate; and
causing the mobile device to scan for network connection at the third scanning rate.

20. The system of claim 15, wherein:
the programmable table stores identifiers of one or more access nodes associated with the telecommunications system,
each identifier is associated with a scanning rate, and
the scanning rates associated with identifiers of extraterrestrial access nodes are higher than the scanning rates of terrestrial scanning nodes.
